(19) United States
(12) Patent Application Publication
(10) Pub. No.: US 2026/0131341 A1
(43) Pub. Date: May 14, 2026

(54) TUBE COMPRISING A HEAD EQUIPPED WITH A PUMP

(71) Applicant: ALBEA SERVICES, Courbevoie (FR)

(72) Inventors: Sylvain DEFERT, Courbevoie (FR); Franck FRITSCH, Courbevoie (FR)

(73) Assignee: ALBEA SERVICES, Courbevoie (FR)

(21) Appl. No.: 19/374,362

(22) Filed: Oct. 30, 2025

(30) Foreign Application Priority Data
Nov. 14, 2024 (FR) FR2412424

(51) Int. Cl. B05B 11/10

(52) U.S. Cl. CPC B05B 11/1047; B05B 11/1001

(57) ABSTRACT

A head for manufacturing a flexible tube is described. The head includes a pump and a shoulder. The pump includes a pump mechanism equipped with a piston sliding axially in a pump body and a push button mounted on the piston and equipped with a dispensing orifice for dispensing the product sucked by the pump. The shoulder is a single-piece component which is delimited externally by an annular peripheral bearing face. The bearing face surrounds a visible segment equipped with a central orifice, where the pump body is configured to be mounted. The shoulder includes a ring formed by an annular wall which extends axially upwards surrounding the central orifice to receive the push button and guide its sliding.

### CROSS-REFERENCE TO RELATED APPLICATIONS

This application claims priority to French Application No. 2412424, filed Nov. 14, 2024, the contents of which is incorporated herein by reference in its entirety.

### TECHNICAL FIELD OF THE INVENTION

The invention relates to a tube head and a flexible tube comprising said tube head.

### TECHNICAL BACKGROUND

The flexible tubes comprise a flexible tubular sleeve, also referred to as a “skirt”, formed for example from a rolled and welded laminate or a tube obtained by extrusion. The flexible tubular sleeve is equipped at its axial end, referred to as the upper end, with a tube head through which a user may squeeze out the product contained in the flexible tubular sleeve. The end of the flexible tubular sleeve is closed, for example pinched and welded.

Flexible tubes are known comprising a tube head equipped with a pump. The pump is used to dispense a dose of the product contained in the tube, in particular a cosmetic product such as a cream, in a clean and repeatable manner.

In addition, by combining a flexible tube with a pump, it is possible to benefit from the advantages of both the pump and the flexible tube. The advantages of the flexible tube include the weight of the material, which is much lower than that of a rigid container of the same capacity. In addition, the flexible tubular sleeve may be deformed during use as the product contained in the tube is extracted. The flexible tubular sleeve is strong enough to form the external envelope of the tube without the need for a rigid external envelope.

Moreover, when the pump used is airless, the pump extracts the product contained in the tube without introducing air, which helps to preserve the product better. The flexible tube allows the volume of the tube to be reduced as the product is extracted, which is not possible with a rigid container.

The tubes equipped with pump comprise a shoulder which is attached to the upper end of the flexible tubular sleeve during a manufacturing step. Then an assembly comprising the pump mounted in a support comprising a guide ring for guiding a push button of the pump is pre-assembled. Advantageously, this assembly may be equipped with a removable cap that covers the push button of the pump. This assembly is then interlocked together with the shoulder, which has been previously attached to the flexible tubular sleeve.

Such a design comprises a large number of elements that have to be manufactured and then assembled.

These numerous parts create sealing problems when the tube is used. It is necessary to ensure a good airtight seal between the shoulder and the support equipped with the guide ring. In general, at least one of the support or the shoulder comprises a lip configured to ensure a sealing contact with the other of the support or the shoulder. However, as the tube empties, the flexible sleeve deforms to accompany the drop in pressure in the tube and force the product back up towards the pump. The deformation of the flexible sleeve creates a stress on the shoulder, which deforms slightly, causing a loss of contact between the lip and the face against which it is pressed.

Furthermore, from both an environmental and an economic point of view, it would be preferable to reduce the quantity of material used to manufacture such a flexible tube head comprising a pump and the flexible tube as a whole.

### SUMMARY OF THE INVENTION

The invention relates to a head for manufacturing a flexible tube having a main axis configured to contain a liquid or pasty product, comprising:
a pump comprising
   a pump mechanism equipped with a piston sliding axially in a pump body and
   a push button mounted on the piston and equipped with a dispensing orifice for dispensing the product sucked by the pump;
a shoulder made in one-part which is delimited externally by an annular peripheral bearing face against which an upper end section of a flexible tubular sleeve of the tube is configured to be folded back to allow its attachment, the bearing face surrounding a visible segment equipped with a central orifice wherein the pump body is configured to be mounted;
   wherein the shoulder comprises a ring formed by an annular wall which extends axially upwards surrounding the central orifice to receive the push button and guide its sliding.

According to another characteristic of the head produced in accordance with the teachings of the invention, the head comprises a cap separate from the shoulder configured to cover the push button and the ring in a closed position wherein the cap is attached in a removable manner by cooperation of shape with an annular attachment section for attaching the shoulder which is radially comprised between the peripheral bearing face and the ring.

According to another characteristic of the head produced according to the teachings of the invention, the annular attachment section is arranged close to the bearing face so that the cap in the closed position covers the entire visible segment of the shoulder.

According to another characteristic of the head produced in accordance with the teachings of the invention, the annular attachment section is located at the base of the ring so that the cap in the closed position covers only the ring and the push button, the visible segment of the shoulder located radially between the ring and the bearing face being outside the cap.

Another characteristic of the head produced in accordance with the teachings of the invention is that the cap is elastically snapped to the annular attachment section by axial interlocking.

Another characteristic of the head produced in accordance with the teachings of the invention is that the cap is attached to the annular attachment section by screwing.

According to another characteristic of the head produced in accordance with the teachings of the invention, the pump body is mounted directly in the central orifice of the shoulder by axial elastic interlocking.

Another characteristic of the head produced in accordance with the teachings of the invention is that the pump body is attached to the shoulder by elastic snap-attachment.

Another characteristic of the head produced according to the teachings of the invention is that the shoulder is made of polyethylene, in particular high-density polyethylene.

Another characteristic of the head produced according to the teachings of the invention is that the cap is made from the same material as the shoulder.

Another characteristic of the head produced according to the teachings of the invention is that the cap is made of polypropylene.

The invention also relates to a flexible tube comprising a head equipped with a pump and a flexible tubular sleeve configured to contain a cosmetic product, the head being produced in accordance with the teachings of the invention and an upper end section of the flexible tubular sleeve being folded back and attached by welding against the bearing face of the shoulder.

Another characteristic of the tube produced according to the teachings of the invention is that the flexible tubular sleeve is obtained by extrusion.

Another characteristic of the tube produced according to the teachings of the invention is that the flexible tubular sleeve is produced by winding and welding a laminate.

The invention also relates to a method for manufacturing the tube according to the teachings of the invention, characterized in that the head, previously equipped with the pump and its cap in the closed position, is then attached to the flexible tubular sleeve by welding.

### BRIEF DESCRIPTION OF THE FIGURES

Further characteristics and advantages of the invention will become apparent from the following detailed description, for the understanding of which reference is made to the attached drawings which are briefly described below.

FIG. 1 is a perspective view of a flexible tube head equipped with a pump produced in accordance with a first embodiment of the invention.

FIG. 2 is a perspective view of a shoulder equipped to the tube head in FIG. 1.

FIG. 3 is an axial cross-section along the sectional plane 3-3 of FIG. 1, showing the tube head equipped with its pump.

FIG. 4 is an axial sectional view showing the tube head of FIG. 3 assembled with a flexible tubular sleeve to form a flexible tube, the head being equipped with a cap.

FIG. 5 is a perspective view of the flexible tube shown in FIG. 4.

FIG. 6 is an axial cross-sectional view of a tube head produced according to a second embodiment of the invention, the head being assembled with a flexible tubular sleeve and equipped with its cap.

FIG. 7 is a perspective view of a shoulder that forms part of the tube head in FIG. 6.

FIG. 8 is a perspective view of the tube head in FIG. 6.

### DETAILED DESCRIPTION OF THE INVENTION

In the rest of the description, elements designated by the same reference have the same structure or similar functions. In the remainder of the description, an axial orientation directed along the main axis of the tube will be adopted, with radial directions extending orthogonally from the main axis of the tube. As indicated by the arrow “A” in the figures, the axial orientation is in particular from bottom to top, from the closed end of the tube towards the head of the tube.

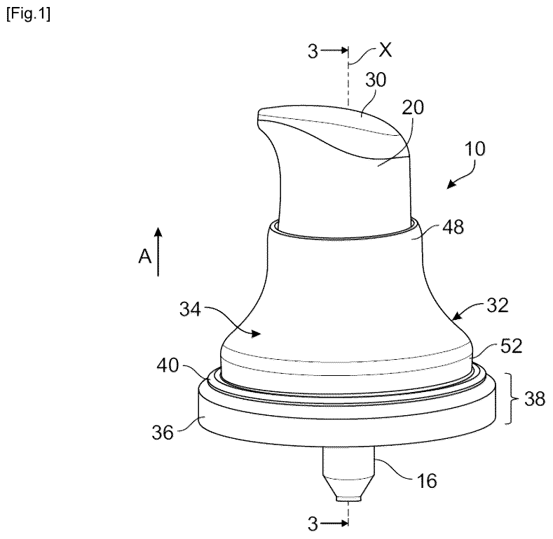

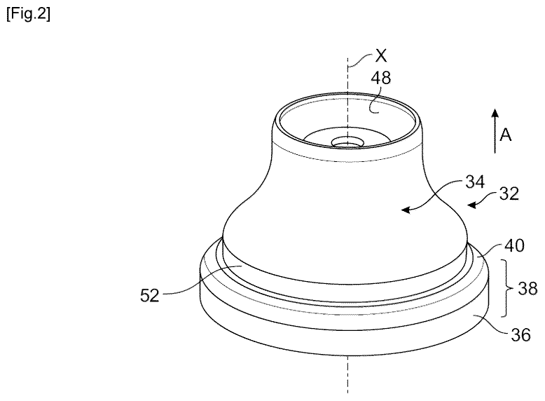

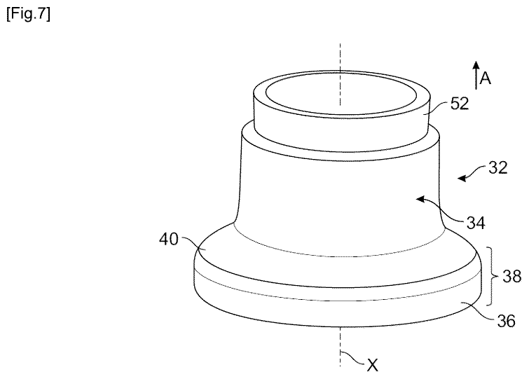

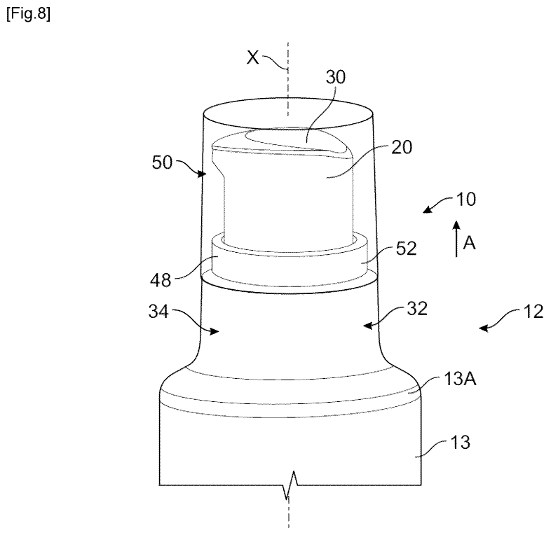

FIGS. 1 to 8 show a head 10 for the manufacturing of a flexible tube 12 with a main axis “X” oriented in the axial direction “A”. As will be explained later, the flexible tube 12 is formed by assembling a flexible tubular sleeve 13 to the head 10. The head 10 is therefore a separate element from the flexible tubular sleeve 13. In particular, the flexible tubular sleeve 13 and the head 10 are produced separately and then assembled at a later step of their production.

The tube 12 is configured to contain a pasty or creamy product, in particular a cosmetic product such as a skin or lip care cream.

In particular, the tube 12 has no rigid envelope enclosing the flexible tubular sleeve 13.

The head 10 comprises a pump 14 for dispensing the product contained in the tube 12. To this end, the product is sufficiently fluid to be dispensed by the pump 14. The pump 14 comprises a pump mechanism 15 and a push button 20.

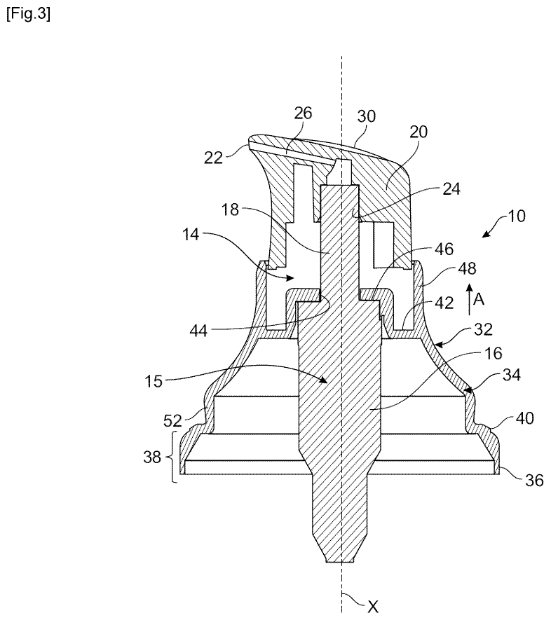

The pump mechanism 15 is shown schematically in FIGS. 3, 4 and 6. Advantageously, this is an “airless” type pump mechanism 15 which does not reintroduce air inside the tube each time it is used. This means that each time the pump mechanism 15 is actuated, the volume of product dispensed is not compensated by air or any other fluid. As a result, the tube 12 empties completely, protecting the product remaining in the tube 12 from oxidation by contact with air.

Associating the flexible tubular sleeve 13 with the airless dispensing pump 14 allows to eliminate the need to equip the dispensing pump 14 with a dip tube to draw off the product from the bottom of the tube 12. As the tubular sleeve 13 is flexible, it automatically deforms under the effect of the drop in pressure in the tube 12 to cause the product to rise to the level of the dispensing pump 14 to draw off the product. This makes optimum use of almost all the product contained and reduces the quantity of plastic material used to manufacture the tube 12 by avoiding the need for a dip tube.

Whatever its embodiment, the pump mechanism 15 comprises a pump body 16, a piston (not shown) mounted so as to slide axially in the pump body 16, and a rod 18 that may move with the piston. The rod 18 projects axially upwards from the pump body 16.

As this is an airless pump mechanism 15, it comprises two non-return valves. The piston is slidably mounted in a chamber (not shown) comprised in the pump body 16. The piston and its rod 18 are resiliently biased upwards. The chamber communicates with the outside by means of an outlet channel, at least a segment of which passes axially through the rod 18. A first non-return valve is arranged along the outlet channel to prevent air from entering the chamber. The chamber also communicates with the interior of the tube 12 by means of a second inlet channel (not shown) which opens into a lower end segment of the pump body 16. A second non-return valve is also arranged in this inlet channel to prevent the product from circulating from the chamber toward the inside of the tube. Each time the pump mechanism 15 is actuated, the piston is urged downwards, pressing axially on the rod 18. This causes a reduction in the volume of the chamber filled with product and therefore an increase in pressure. The presence of the second non-return valve means that the product may only exit through the outlet channel. When the rod 18 is released, the piston is resiliently returned to its original position, increasing the volume of the chamber. Under the effect of the resulting drop in pressure, and due to the presence of the first non-return valve, the product present in the tube 12 is sucked through the inlet channel. This causes a drop in pressure in the tube 12, which deforms to reduce the internal volume of the tube 12 and balance the internal pressure with the external pressure.

Whatever the embodiment of the pump mechanism 15, the pump 14 comprises a push button 20 mounted on the piston rod 18. The push button is equipped with an orifice 22 for dispensing the product sucked by the pump mechanism 15. The push button 20 is in the form of a dome comprising internally a housing 24 for interlocking with the free end of the rod 18. The bottom of the housing communicates with the dispensing orifice 22 by means of a channel 26 which is connected to the portion of the outlet channel that opens out at the free end of the rod 18.

By way of a non-limiting example, the dispensing orifice 22 is located at the end of a radial spout 28 of the push button 20.

The push button 20 also comprises an upper face 30 that may be actuated by means of a finger or the palm of the hand.

The head 10 also comprises a shoulder 32 made in one-part.

The shoulder 32 is made by molding, for example. For example, it is made of a rigid plastic material such as polyethylene, in particular high density polyethylene (HDPE).

The shoulder 32 has an annular wall 34 which is configured to close the tube 12 axially upwards.

The annular wall 34 is, for example, hollow and generally frustoconical in shape. It extends here, flaring out from top to bottom. In axial cross-section, the annular wall 34 may have a complex shape with rounded edges and/or steps.

In a variant of the invention not shown, the annular wall 34 has a flat shape extending in a radial plane.

The shoulder 32 is delimited externally by an annular peripheral bearing face 36 against which an upper end section of the flexible tubular sleeve 13 of the tube 12 is configured to be folded back to allow it to be attached by welding, as will be explained later. The bearing face 36 is thus located on a segment of the shoulder 32 which is configured to be comprised inside the flexible tubular sleeve 13. In the embodiment shown in the figures, no element of the shoulder 32 extends radially outwards relative to the upper end section of the flexible tubular sleeve 13.

The bearing face 36 is located on a skirt 38 which extends axially downwards from an external and lower peripheral end of the wall 34.

The annular wall 34 is configured to form a visible segment of the shoulder 32 when the latter is assembled with the flexible tubular sleeve 13, while the bearing face 36 and the skirt 38 which bears it are configured to form a concealed segment which is configured to be fitted inside the flexible tubular sleeve 13 of the tube 12. The skirt 38 is delimited at the bottom by a lower end edge which extends in a plane orthogonal to the main axis “X”.

The bearing face 36 thus surrounds the entire visible segment formed by the annular wall 34.

The shoulder 32 also comprises an annular shoulder face 40 projecting upwards relative to the peripheral bearing face 36. It delimits the peripheral bearing face 36 relative to the annular wall 34 forming the visible portion.

The bearing face 36 is staged in relation to the periphery of the annular wall 34 visible from the shoulder 20. The peripheral bearing face 36 and the shoulder face 40 thus form a rebate to receive the folded end section of the flexible tubular sleeve 13, as will be explained later.

At its center, the annular wall 34 has a radial wall 42 which extends in a radial plane, orthogonal to the axis “X” of the head 10. This radial wall 42 is equipped with a central orifice 44 wherein the pump body 16 is configured to be mounted. More particularly, the pump mechanism 15 is mounted so that the lower end segment of the pump body 16 into which the inlet channel opens is located below the radial wall 42, inside the tube 12, while the upper end of the pump body 16 is located above the radial wall 42, outside the tube 12.

The pump body 16 is attached to the radial wall 42 by any suitable means. The pump body 16 is preferably mounted directly in the central orifice 44 of the shoulder 32, without using an intermediate part. This allows to reduce the amount of material, particularly plastic, used to manufacture the tube 12.

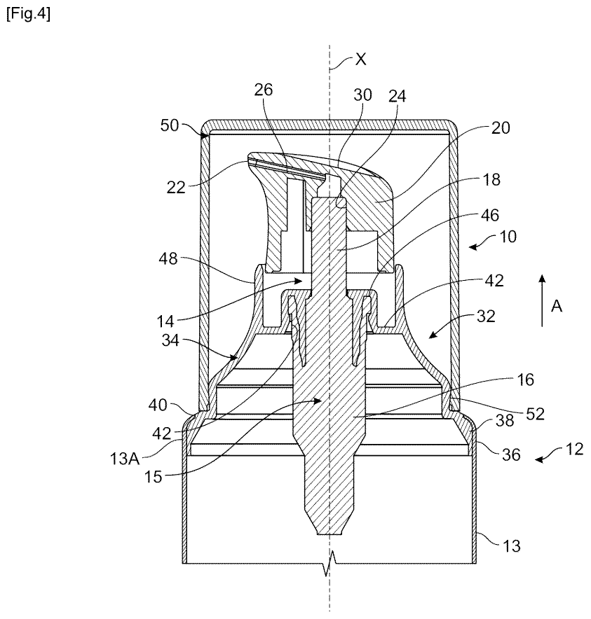

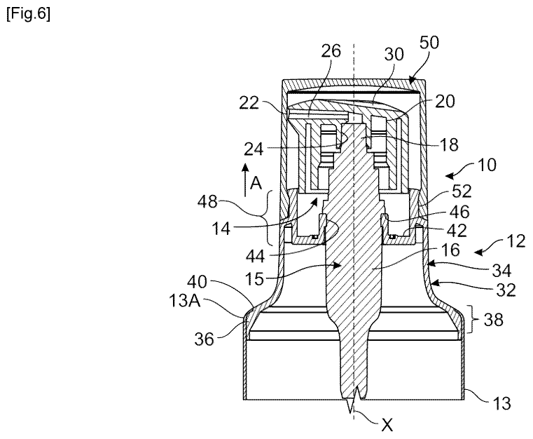

The pump body 16 is attached by axial interlocking into the central orifice 44. It may be interlocked from below, as shown in FIGS. 3 and 4, or from above, as shown in FIG. 6. In all cases, the pump body 16 comprises an annular stop 46 which allows to stop the axial translation of the pump body 16 by axial abutment against a face facing the shoulder 32.

The pump body 16 is attached to the shoulder by elastic snap-attachment of complementary shapes. This is preferably a non-reversible elastic snap-attachment to prevent the pump mechanism 15 from being withdrawn once the tube 12 is filled with product.

In a variant not shown, the pump body 16 is attached to the shoulder 32 by screwing or welding.

The shoulder 32 comprises a ring 48 formed by a cylindrical wall which extends axially upwards from the periphery of the radial wall 42, surrounding the central orifice 44. The ring 48 radially delimits a housing for receiving the push button 20. The housing is delimited axially downwards by the radial wall 42.

The ring 48 is configured to guide the push button 20 to slide axially relative to the shoulder 32. To this end, the ring 48 has an inner face complementary to the outer face of the push button 20. The ring 48 is designed specifically to guide the push button 20 and in particular to prevent it from jamming when it slides sideways.

The head 10 also comprises a cap 50 separate from the shoulder 32. The cap 50 is configured to cover the push button 20 and the ring 48 when it is in the closed position.

In its closed position, the cap 50 is removably attached by positive engagement with an annular attachment section 52 for attaching the shoulder 32. More specifically, a section 52 of the visible annular wall 34 is radially comprised between the peripheral bearing face 36 and the ring 48.

The cap 50 is elastically snapped to the annular attachment section 52 by axial interlocking. This is a reversible attachment so that the cap 50 may be easily removed to use the tube 12.

For example, one of the inner face of the cap 50 or the attachment section 52 comprises a bead, while the other of the inner face of the cap 50 or the attachment section 52 comprises a gorge for receiving said bead by elastic deformation of the wall of the cap 50.

In a variant not shown, the cap is attached to the annular attachment section by screwing.

According to a first embodiment shown in FIGS. 1 to 5, the annular attachment section 52 is arranged close to the bearing face 36 so that the cap 50 in the closed position covers the entire annular wall 34 visible from the shoulder 32.

The attachment section 52 forms an external peripheral section of the visible annular wall 34.

This embodiment allows to protect the entire head 10 of the tube 12 by means of the cap 50.

According to a second embodiment shown in FIGS. 6 to 8, the annular attachment section 52 is located at the base of the ring 48. The annular attachment section 52 is more particularly formed by the outer face of the ring 48.

The cap 50 in the closed position covers only the ring 48 and the push button 20. The annular wall 34 visible from the shoulder 32 located radially between the ring 48 and the bearing face 36 remains outside the cap 50 when it is in its closed position.

This second embodiment allows to obtain an even lighter tube 12 by further reducing the quantity of material, particularly plastic, used in its manufacture. In either embodiment, the cap 50 is made from the same plastic material as the shoulder 32. This allows to simplify the recycling of the tube 12. The cap 50 is made of polyethylene, in particular high-density polyethylene (HDPE).

In a variant of the invention not shown, the cap 50 is made from a different material to that of the shoulder 32, for example polypropylene (PP). This production is particularly suitable when the proportion by weight of the cap 50 is relatively low compared to the weight of the rest of the head 10 and of the tube 12.

This configuration of the head 10, wherein the pump is mounted directly in the shoulder 32, allows to eliminate the risk of air leakage that existed in prior art tubes wherein the pump is mounted on a support which is then attached to the shoulder.

During the manufacture of the tube 12, the head 10 produced in accordance with the teachings of the invention is pre-assembled. In this way, the dispensing pump 14 is mounted in the central orifice 44 of the shoulder 32 and the cap 50 is mounted in its closed position on the shoulder 32.

The skirt 38 of the shoulder 32 is then inserted into the flexible tubular sleeve 13, which has previously been shaped into a tube.

The tubular sleeve 13 is made, for example, by winding and welding the two adjoining edges of a sheet of laminate together, in particular overlapping.

Alternatively, the flexible tubular sleeve 13 is produced directly in its tubular configuration by extrusion.

An upper end section 13A of the flexible tubular sleeve 13 is folded back against the peripheral bearing face 36 so that the upper end edge of the flexible tubular sleeve 13 is substantially arranged against the shoulder face 40. The bearing face 36 and the upper end section 13A of the flexible tubular sleeve 13 are then attached together.

The bearing face 36 and the upper end section 13A of the flexible tubular sleeve 13 are welded together, for example by heating with hot air or by ultrasonic welding. To this end, the flexible tubular sleeve 13 comprises a wall with at least one internal layer of weld configured to be in contact with the tube head 10. The weld layer is made, for example, of a plastic material compatible with the material forming the shoulder 32, for example polyethylene (PE).

Once this assembly operation is performed, the tube 12 may be filled with product through the lower opening of the flexible tubular sleeve 13.

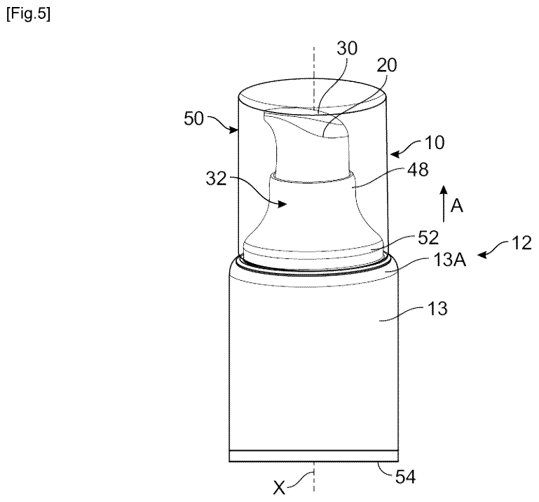

The lower end is then closed, for example by a welded clamp 54, as shown in FIG. 5.

The tube head 10 produced according to the teachings of the invention and the tube 12 thus obtained allow to significantly reduce the quantity of material used in its manufacture.

In addition, the same tube head 10 may be adapted to flexible tubular sleeves 13 of different composition which are adapted to the product contained. This allows to simplify the manufacture of the tube 12 and to obtain a tube that is particularly suited to the product it is configured to contain. This also means that the flexible tubular sleeve 13 may be produced freely without any material or method constraints.

1. A head for manufacturing a flexible tube having a main axis configured to contain a liquid or pasty product, comprising:
a pump comprising:
a pump mechanism equipped with a piston sliding axially in a pump body and
a push button mounted on the piston and equipped with a dispensing orifice for dispensing the product sucked by the pump;
a shoulder made in one-part which is delimited externally by an annular peripheral bearing face against which an upper end section of a flexible tubular sleeve of the tube is configured to be folded back to allow its attachment, the bearing face surrounding a visible segment equipped with a central orifice wherein the pump body is configured to be mounted;
wherein the shoulder comprises a ring formed by an annular wall which extends axially upwards surrounding the central orifice to receive the push button and guide its sliding.

2. The head according to claim 1, characterized in that the head comprises a cap separate from the shoulder configured to cover the push button and the ring in a closed position wherein the cap is attached in a removable manner by cooperation of shape with an annular attachment section for attaching the shoulder which is radially comprised between the peripheral bearing face and the ring.

3. The head according to claim 2, characterized in that the annular attachment section is arranged close to the bearing face so that the cap in the closed position covers entirety of the visible segment of the shoulder.

4. The head according to claim 2, characterized in that the annular attachment section is located at a base of the ring so that the cap in the closed position covers only the ring and the push button, the visible segment of the shoulder located radially between the ring and the bearing face being outside the cap.

5. The head according to claim 2, characterized in that the cap is elastically snapped to the annular attachment section by axial interlocking.

6. The head according to claim 2, characterized in that the cap is attached to the annular attachment section by screwing.

7. The head according to claim 1, characterized in that the pump body is mounted directly in the central orifice of the shoulder by axial elastic interlocking.

8. The head according to claim 7, characterized in that the pump body is attached to the shoulder by elastic snap-attachment.

9. The head according to claim 1, characterized in that the shoulder is made of polyethylene, in particular high density polyethylene.

10. The head according to claim 2, characterized in that the cap is made of the same material as the shoulder.

11. The head according to claim 2, characterized in that the cap is made of polypropylene.

12. A tube comprising a head equipped with a pump and a flexible tubular sleeve configured to contain a cosmetic product, the head being produced according to claim 1 and an upper end section of the flexible tubular sleeve being folded back and attached by welding against the bearing face of the shoulder.

13. The tube according to claim 12, characterized in that the flexible tubular sleeve is obtained by extrusion.

14. The tube according to claim 12, characterized in that the flexible tubular sleeve is produced by winding and welding a laminate.

15. A method for manufacturing the tube according to claim 12, characterized in that the head previously equipped with the pump and its cap in a closed position is then attached to the flexible tubular sleeve by welding.
